(19) United States
(12) Patent Application Publication
(10) Pub. No.: US 2014/0025511 A1
(43) Pub. Date: Jan. 23, 2014

(54) SkratchAds

(71) Applicants: Douglas Finley Morrison, Dublin, CA (US); Cameron Ahad Nazeri, Walnut Creek, CA (US)

(72) Inventors: Douglas Finley Morrison, Dublin, CA (US); Cameron Ahad Nazeri, Walnut Creek, CA (US)

(73) Assignee: MPRNT INC, Walnut Creek, CA (US)

(21) Appl. No.: 13/943,552

(22) Filed: Jul. 16, 2013

Related U.S. Application Data
(60) Provisional application No. 61/673,718, filed on Jul. 19, 2012.

(51) Int. Cl. G06Q 30/02

(52) U.S. Cl. CPC G06Q 30/0276
USPC 705/14.72

(57) ABSTRACT

Disclosed is a method for creating an interactive banner (virtual “scratch” ad) for a touch screen that suggests a redemption value may be obtained, displaying an interactive banner that suggests a redemption value may be obtained, processing touches on a screen displaying the interactive banner, converting the pixels below the touches to transparent to mimic “scratch offs”, displaying a message of winning a redemption value or of not winning a redemption value, providing advertising, and redirecting a user to a source of the redemption value. The method for creating an interactive banner that suggests a redemption value may be obtained receives a plurality of inputs pertaining to an interactive banner, messages of congratulation or condolence, and advertisements.

### CROSS-REFERENCE TO RELATED APPLICATION

This application claims the benefit of priority of U.S. Provisional Patent Application 61/673,718 filed Jul. 19, 2012 and titled “SkratchAds,” the disclosure of which is incorporated by reference.

### BACKGROUND OF THE INVENTION

1. Field of Invention

The invention relates generally to the field of software, and more specifically to programs for displaying advertising on mobile devices and other display interface devices.

2. Description of Related Art

Software ads are generally static. Some software ads have animation, which is the successive display of different images. Software ads include embed links so that a touch on a conductive screen displaying the ad redirects the display to a website. These ads have limited interactivity with the user of the device.

### SUMMARY OF THE INVENTION

Disclosed is a process for creating an interactive banner (virtual “scratch” ad) for a touch screen that suggests a redemption value may be obtained, displaying an interactive banner that suggests a redemption value may be obtained, processing touches on the screen displaying the interactive banner, converting the pixels below the touches to transparent to mimic “scratch offs”, displaying a message of winning a redemption value or of not winning a redemption value, providing advertising, and redirecting a user to a source of the redemption value.

The process for creating an interactive banner (virtual “scratch” ad) that suggests a redemption value may be obtained receives a plurality of inputs pertaining to an interactive banner, messages of congratulation or condolence, and advertisements.

The inputs may comprise image size information. The image size information may be pixel values.

The inputs may comprise text. The inputs may comprise a digital image. The inputs may comprise both text and a digital image.

In some embodiments, a conductive touch is received to cause display of a message indicating a WIN (e.g., “CONGRATULATIONS”) or a LOSS (e.g., TRY AGAIN LATER”).

### BRIEF DESCRIPTION OF THE DRAWINGS

FIG. 1 shows a consolidated exemplary screenshot for a process for receiving inputs to create an interactive banner that suggests a redemption value may be obtained.

FIGS. 2A and 2B shows an exemplary process for receiving inputs to create an interactive banner that suggests a redemption value may be obtained.

FIG. 3 shows the process for assigning a prize to a scratch banner for a WIN banner.

FIG. 4 shows an exemplary process for displaying an interactive (virtual scratch) banner that suggests a redemption value may be obtained and for receiving and processing touch screen interactions.

FIG. 5 shows an exemplary process displaying an interactive banner that suggests a redemption value may be obtained and displaying a WIN banner.

FIG. 6 shows an exemplary process displaying an interactive banner that suggests a redemption value may be obtained and displaying a LOSE banner.

FIG. 7 shows an exemplary animation image displaying a WIN banner with the word CONGRATULATIONS! from steps 520 and 525.

FIG. 8 shows an exemplary process for displaying an interactive screen for collecting Personal Contact Information, and sending the Personal Contact Information to a server.

### DETAILED DESCRIPTION OF THE INVENTION

Embodiments are directed to a process for creating an interactive banner (virtual scratch ad) that suggests a redemption value may be obtained, displaying the interactive banner that suggests a redemption value may be obtained, processing touches on the screen space displaying the interactive banner, and providing advertising and redirecting a user to a source of the redemption value.

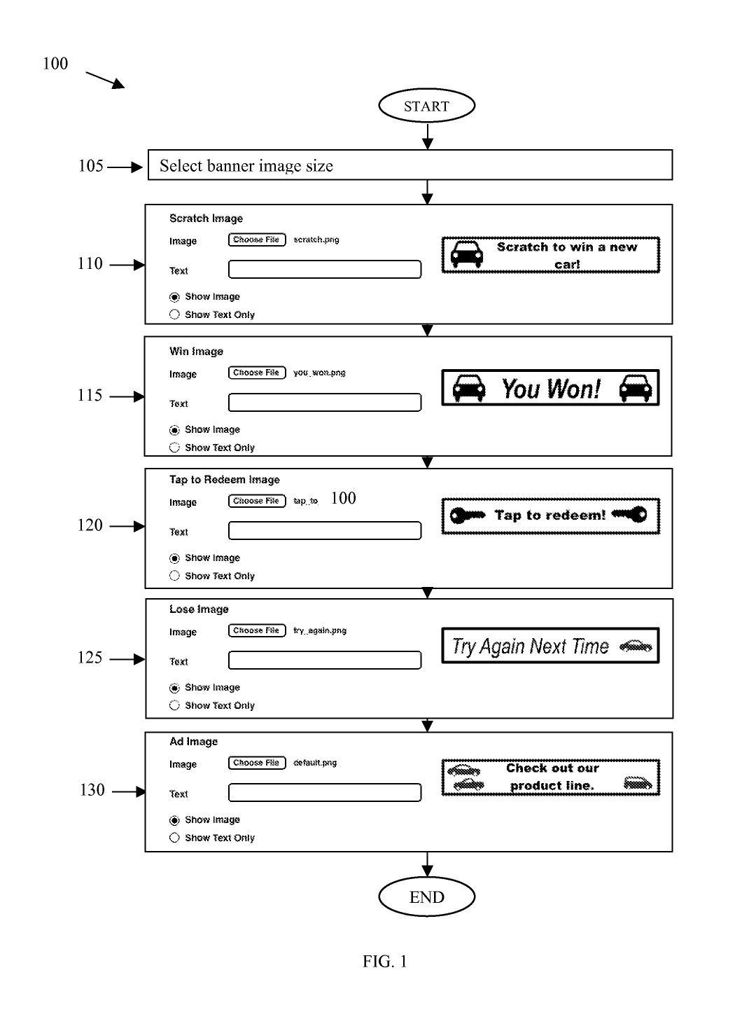

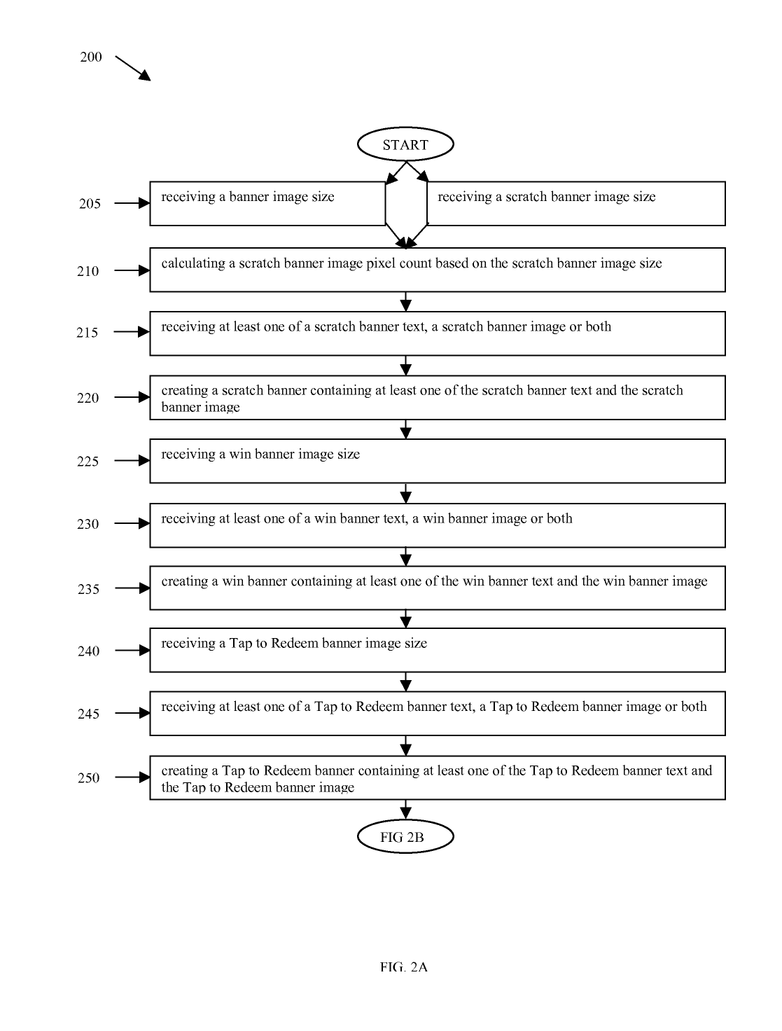

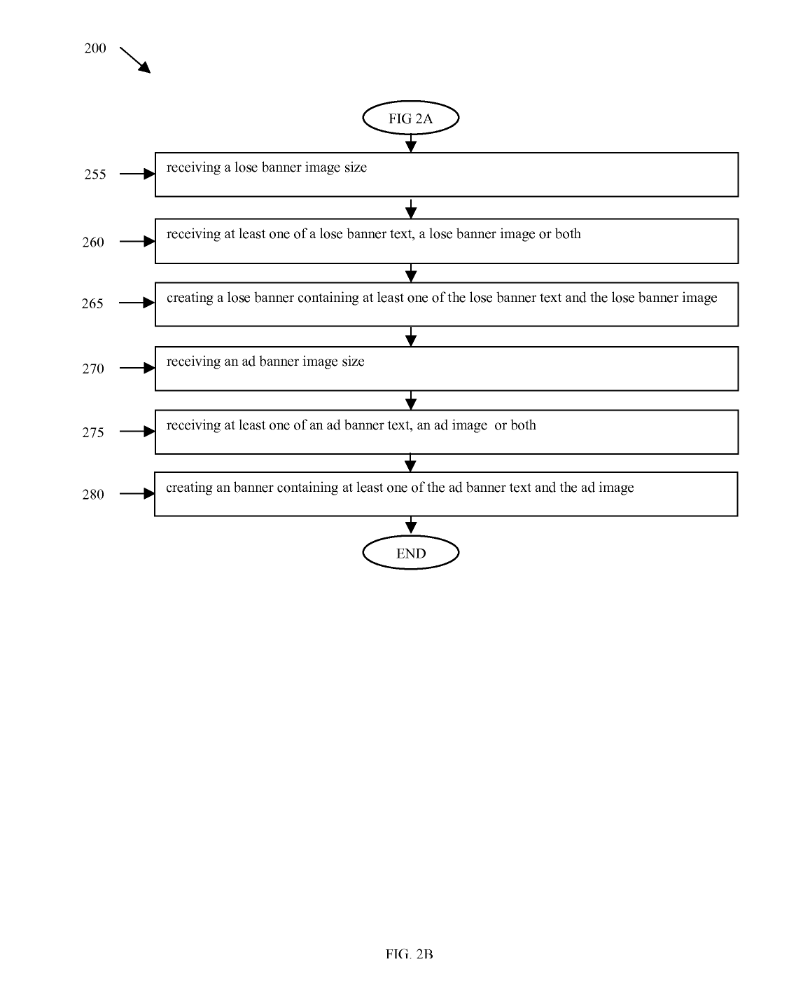

FIG. 1 shows a consolidated exemplary screenshot for a process for receiving inputs to create an interactive banner that suggests a redemption value may be obtained. The detailed steps for the consolidated exemplary screenshot for a process for receiving inputs to create an interactive banner that suggests a redemption value may be obtained are shown in FIGS. 2A and 2B.

FIG. 1 also shows several exemplary banners that are merely illustrative embodiments and teachings of the present invention. All variations are within the spirit and scope of the present invention. These exemplary banners are not to be considered as limiting the present invention to only the embodiments illustrated.

At Step 105, the step may comprise receiving at least one of a scratch banner image size, a win banner image size, a Tap to Redeem banner size, a lose banner size, or an ad banner image size the size of the banner.

Generally, all banners are the same size, though this is not necessary. In those embodiments, the step would comprise receiving a predetermined banner image size. The time of predetermination may be at any time, i.e., one size fixed in the process, or determined from a selection of sizes and applied to all banners. A banner may be sized according to an industry or company standard, as noted earlier, or may another width or height.

Interactive banner sizes may be based on display formats and screen sizes. Either or both may be standardized by technology, marketing or other criteria. Two examples of banner standardizations are text, such as 35 characters of text, and tiles, which may be 38×38 or 72×72. Other standardized banner sizes for smartphones and feature phones include XL (300×50), L (216×36), M (168×28) and S (120×20). Tablets may have standardized sizes of Med. Rectangle (300×250), Standard Banner (468×60) or Leaderboard (728×90).

Two entities active in the banner advertising industry are Google Admob (https://support.google.com/admob/answer/1620077?hl=en) and Interactive Advertising Bureau (http://www.iab.net/ad_unit), both of which provide standards.

In some embodiments, the banner image size may be 320 pixels by 50 pixels. In some embodiments, a banner image size may be 760 pixels by 100 pixels. In most embodiments, the banners would be the width of a touch screen, although any banner may be smaller, or even larger than the width of a touch screen.

At Step 110, the step comprises receiving options for a SCRATCH banner comprising receiving at least one of an image file, text, or an image file and text, as well as for providing an input to Show Image, or to Show Text Only. Some embodiments may provide for an input to Show Image and Text.

At Step 115, the step comprises receiving options for a WIN banner comprising receiving at least one of an image file, text, or an image file and text, as well as for receiving an input of whether to Show Image, or to Show Text Only. Some embodiments may provide for an input to Show Image and Text.

At Step 120, the step comprises receiving options for a TAP TO REDEEM banner comprising receiving at least one of an image file, text or an image file and text, as well as for providing an input to Show Image, or to Show Text Only. Some embodiments may provide for an input to Show Image and Text.

At Step 125, the step comprises receiving options for a LOSE banner comprising receiving at least one of an image file, text, or an image file and text, as well as for providing an input to Show Image, or to Show Text Only. Some embodiments may provide for an input to Show Image and Text.

At Step 130, the step comprises receiving options for an AD banner, comprising receiving at least one of an image file, text, or an image file and text, as well as for providing an input to Show Image, or to Show Text Only. Some embodiments may provide for an input to Show Image and Text.

FIGS. 2A and 2B shows an exemplary process for receiving inputs to use to create an interactive banner that suggests a redemption value may be obtained.

At step 205, the step comprises receiving a scratch banner image size. In some embodiments, all banners are the same size, so the step would comprise receiving a predetermined banner image size. In some embodiments, a scratch banner image size may be 320 pixels by 50 pixels. In some embodiments, a scratch banner image size may be 760 pixels by 100 pixels. The SCRATCH banner may be sized according to an industry or company standard, as noted earlier, or may another width or height. In most embodiments, the SCRATCH banner would be the width of a touch screen, although any banner may be smaller, or even larger than the width of a touch screen.

At step 210, the step comprises calculating a scratch banner image pixel count based on the scratch banner image size. This step is not needed in embodiments with a fixed scratch banner size.

At step 215, the step comprises receiving at least one of a scratch banner text, a scratch banner image, or both. In some embodiments, a scratch banner text may be SCRATCH TO WIN, or perhaps SCRATCH HERE TO WIN.

At step 220, the step comprises creating a SCRATCH banner containing at least one of the scratch banner text and the scratch banner image.

At step 225, the step comprises receiving a win banner image size (unless a single banner size is allied to all banners). In some embodiments, a win banner image size may be 320 pixels by 50 pixels. In some embodiments, a win banner image size may be 760 pixels by 100 pixels. In most embodiments, the WIN banner would be the width of a touch screen, although the WIN banner may be smaller, or even larger than the width of a touch screen.

At step 230, the step comprises receiving at least one of a win banner text, a win banner image, or both.

At step 235, the step comprises creating a WIN banner containing at least one of the win banner text and the win banner image.

At step 240, the step comprises receiving a Tap to Redeem banner image size (unless a single banner size is allied to all banners). In some embodiments, a Tap to Redeem banner image size may be 320 pixels by 50 pixels. In some embodiments, a Tap to Redeem banner image size may be 760 pixels by 100 pixels. In most embodiments, the TAP TO REDEEM banner would be the width of a touch screen, although the TAP TO REDEEM banner may be smaller, or even larger than the width of a touch screen.

At step 245, the step comprises receiving at least one of a Tap to Redeem banner text, a Tap to Redeem banner image, or both.

At step 250, the step comprises creating a Tap to Redeem banner containing at least one of the Tap to Redeem banner text and the Tap to Redeem banner image.

At step 255, the step comprises receiving a lose banner image size (unless a single banner size is allied to all banners). In some embodiments, a lose banner image size may be 320 pixels by 50 pixels. In some embodiments, a lose banner image size may be 760 pixels by 100 pixels. In most embodiments, the LOSE banner would be the width of a touch screen, although the LOSE banner may be smaller, or even larger than the width of a touch screen.

At step 260, the step comprises receiving at least one of a lose banner text, a lose banner image, or both.

At step 265, the step comprises creating a LOSE banner containing at least one of the lose banner text and the lose banner image.

At step 270, the step comprises receiving an ad banner image size (unless a single banner size is allied to all banners). In some embodiments, the ad banner image size may be 320 pixels by 50 pixels. In some embodiments, the ad banner image size may be 760 pixels by 100 pixels. In most embodiments, the AD banner would be the width of a touch screen, although the AD banner may be smaller, or even larger than the width of a touch screen.

At step 275, the step comprises receiving at least one of an ad banner text, an ad banner image, or both.

At step 280, the step comprises creating an AD banner containing at least one of the ad banner text and the ad banner image. An AD banner is an advertisement typically displayed after a LOSE banner.

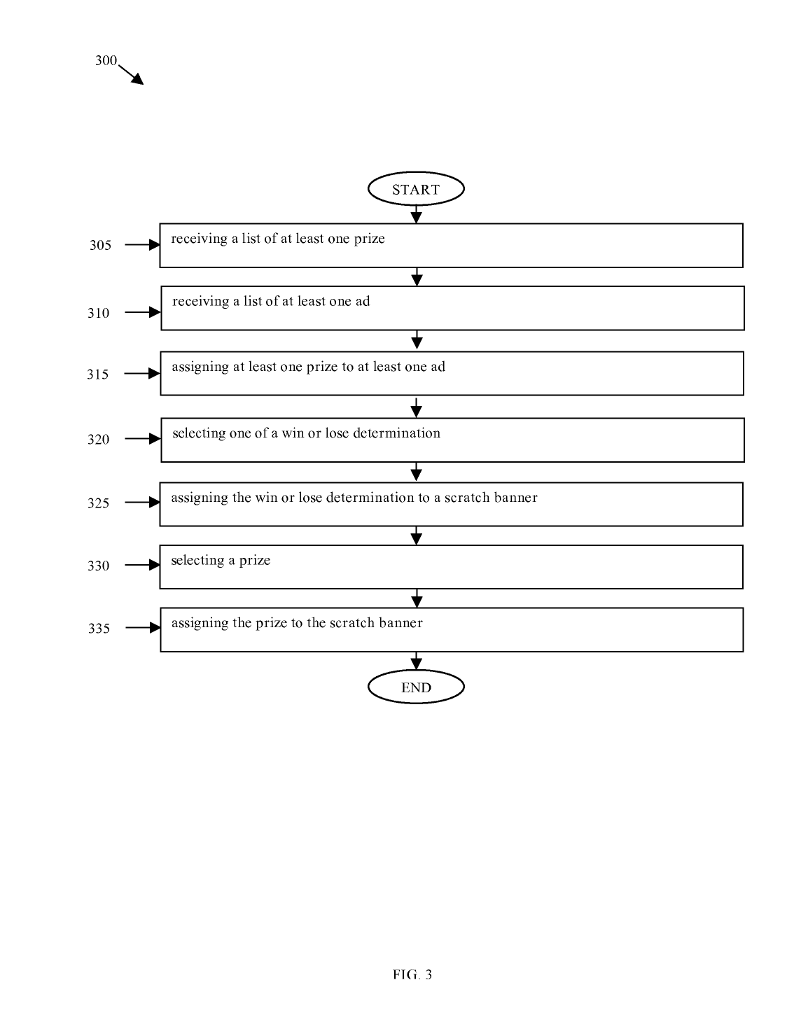

FIG. 3 shows the process for assigning a prize to a SCRATCH banner for a WIN banner.

At step 305, the step comprises receiving a list of at least one prize. In some embodiments, this step is predetermined or optional. Step 305 is interchangeable with step 310.

At step 310, the step comprises receiving a list of at least one ad. In some embodiments, this step is predetermined or optional. Step 310 is interchangeable with step 305.

At step 315, the step comprises assigning at least one prize to at least one ad. In some embodiments, this step is predetermined or optional. If there is no prize, or ad, then this step is not needed.

At step 320, the step comprises selecting one of a WIN or LOSE determination. The WIN or LOSE determination may be made through any process or algorithm. In some embodiments, a randomization process may be used for the WIN or LOSE determination. In some embodiments, the time of determination (i.e., WIN if the last digit in the time register is odd and LOSE if the last digit in the time register is even, or vice versa) may be used for the WIN or LOSE determination. In some embodiments, the process may be designed to generate all WIN determinations. In some embodiments, the process may be designed to generate all LOSE determinations. In these embodiments, the WIN or LOSE determination is basically by predetermination, i.e., optional.

At step 325, the step comprises assigning the WIN or LOSE determination to a SCRATCH banner. If the WIN or LOSE is predetermined, then the WIN or LOSE assignment is predetermined. In those embodiments, this step is optional.

At step 330, the step comprises selecting a prize. In most embodiments, this step occurs IF the determination is a WIN.

At step 335, the step comprises assigning the prize to the SCRATCH banner. In most embodiments, this step occurs IF the determination is a WIN.

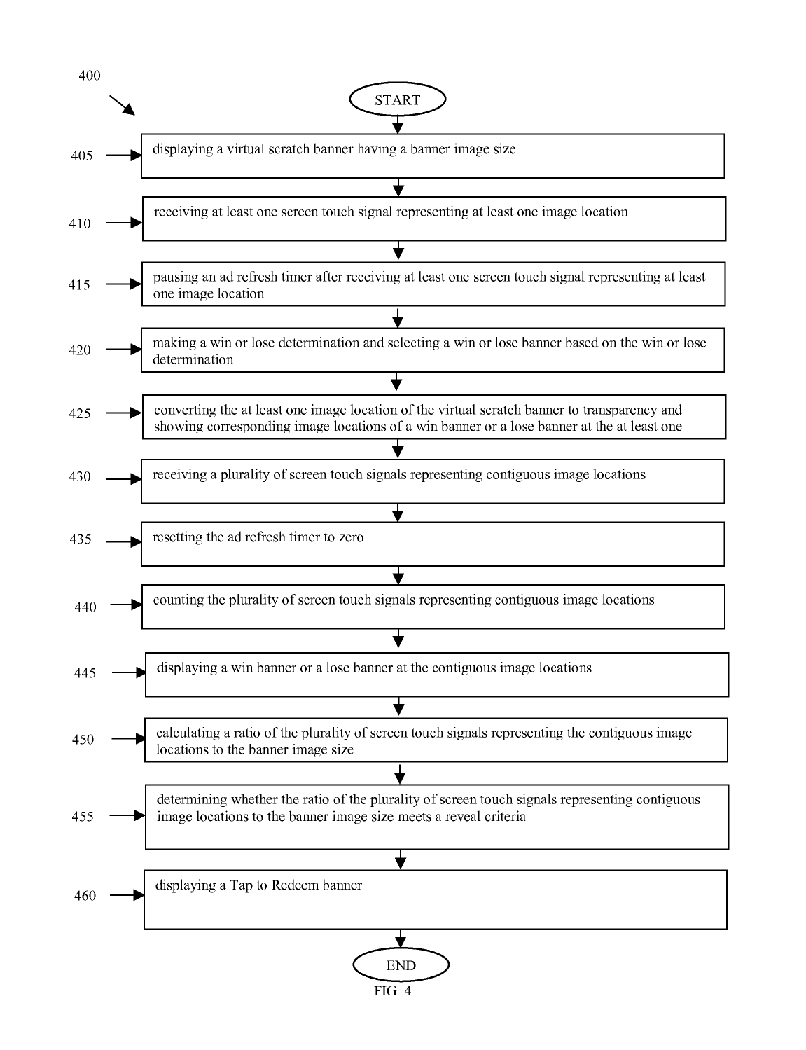

FIG. 4 shows an exemplary process for displaying an interactive (virtual scratch) banner that suggests a redemption value may be obtained and for receiving and processing touch screen interactions.

At step 405, the step comprises displaying a virtual scratch banner having a banner image size. The virtual scratch banner displays the image, text, or an image and text as entered in steps 115 and 215. In most embodiments, the virtual scratch banner would be the width of a touch screen, although the virtual scratch banner may be smaller, or even larger than the width of a touch screen. The banner image size is typically the number of pixels (e.g., bits or dots, etc.) in the banner image.

At step 410, the step comprises receiving at least one screen touch signal representing at least one image location. In some embodiments, the screen touch signal may represent a single pixel. In some embodiments, the screen touch signal may represent a plurality of pixels.

At step 415, the step comprises pausing an ad refresh timer while receiving at least one screen touch signal representing at least one image location.

At step 420, the step comprises making a WIN or LOSE determination and selecting a WIN banner or a LOSE banner based on the WIN or LOSE determination. The WIN or LOSE determination may be made through any process. In some embodiments, a randomization process may be used for the WIN or LOSE determination. In some embodiments, the time of determination (i.e., WIN if the last time digit in the time register is odd and LOSE if the last time digit in the time register is even, or vice versa) may be used for the WIN or LOSE determination. In some embodiments, the process may be designed to generate all WIN determinations. In some embodiments, the process may be designed to generate all LOSE determinations. In these embodiments, the WIN or LOSE determination is basically by default if not optional. The selection of a specific WIN banner or a LOSE banner may, like the WIN or LOSE determination, be based on any process, such as randomization, time, a predetermination, etc. This step may occur at any time before step 425.

At step 425, the step comprises converting the at least one image location of the virtual scratch banner to transparency and showing corresponding image locations of a win banner or a lose banner at the at least one image location

At step 430, the step comprises receiving a plurality of screen touch signals representing contiguous image locations.

At step 435, the step comprises resetting the ad refresh timer to zero. In some embodiments, the resetting of the refresh timer occurs after receiving at least one screen touch signal. In some embodiments, the resetting of the refresh timer occurs after receiving a plurality of screen touch signals representing contiguous image locations. (In effect, the refresh timer is reset to zero when the finger is lifted, even if the finger went down and right back up again without scratching.) The ad refresh timer is set to zero to allow time for more screen touches to reveal the WIN or LOSE banner. In most embodiments, the ad refresh timer is set to zero at the end of each ‘scratch’, i.e., receiving a plurality of screen touch signals representing contiguous image locations. In some embodiments, the ad refresh timer might be set to another time, or paused.

At step 440, the step comprises counting the plurality of screen touch signals representing contiguous image locations. This step may be interchanged with the step of displaying the one of a plurality of win/lose banners at the contiguous image locations.

At step 445, the step comprises displaying a win banner or a lose banner at the contiguous image locations. This step may be interchanged with the step of counting the plurality of screen touch signals representing contiguous image locations.

At step 450, the step comprises calculating a ratio of the plurality of screen touch signals representing the contiguous image locations to the banner image size.

At step 455, the step comprises determining whether the ratio of the plurality of screen touch signals representing contiguous image locations to the banner image size meets a reveal criteria. In some embodiments, the reveal criteria is about 65 percent. In most embodiments, the reveal criteria is exceeds 10 percent.

At step 460, the step comprises displaying a TAP TO REDEEM banner. This step occurs if the ratio of the plurality of screen touch signals representing contiguous image locations to a total of screen touch signals representing contiguous image locations meets the reveal criteria.

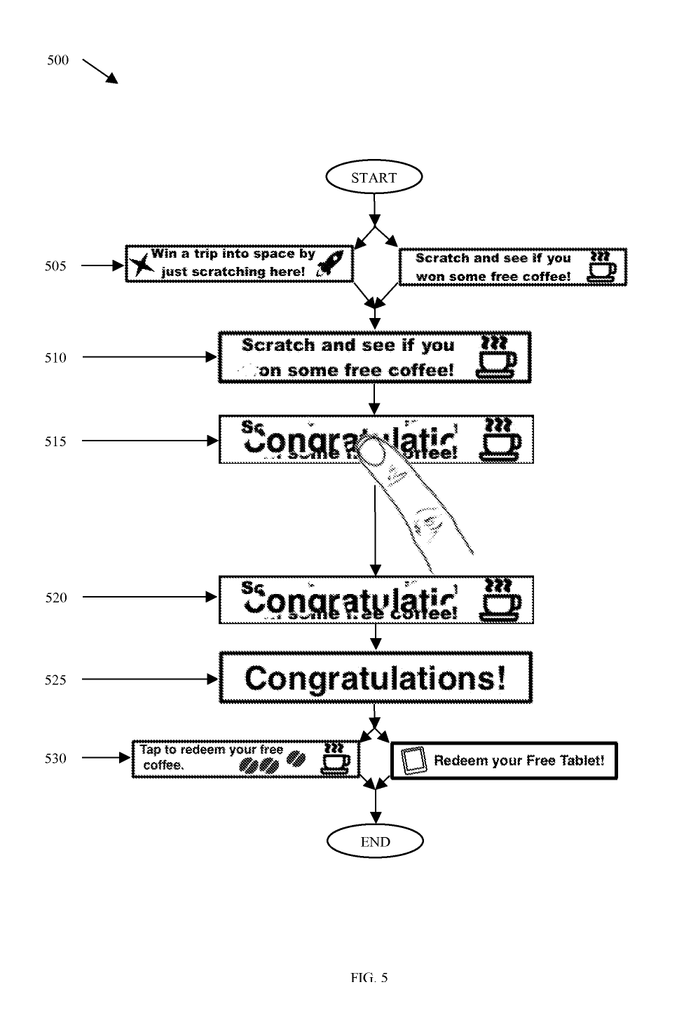

FIG. 5 shows an exemplary process displaying an interactive banner that suggests a redemption value may be obtained and displaying a WIN banner.

At step 505, the step comprises displaying a SCRATCH banner. The SCRATCH banner displays the image, text or an image and text as entered in steps 110 and 215. FIG. 5 shows two examples of SCRATCH banners.

The SCRATCH banner can be of any size. In some embodiments, the SCRATCH banner image size is fixed, i.e., predetermined, so this step in optional in those embodiments. In some embodiments, the SCRATCH banner is 320 pixels by 50 pixels. In some embodiments, the SCRATCH banner image size may be 760 pixels by 100 pixels. The SCRATCH banner may be sized according to an industry or company standard, as noted earlier, or may another width or height. In most embodiments, the SCRATCH banner would be the width of a touch screen, although the SCRATCH banner may be smaller, or even larger than the width of a touch screen.

At step 510, the step comprises receiving at least one screen touch signal representing at least one image location. As shown on the image at step 510, a tap (here, a rather wide one) on the screen where “won” appears caused the pixels to become transparent. The underlying banner then begins to appear.

At step 515, the step comprises receiving a plurality of screen touch signals representing contiguous image locations. As more screen touches are received, more of the underlying banner appears.

Step 520 shows step 515 without a user's finger to show the partial WIN banner.

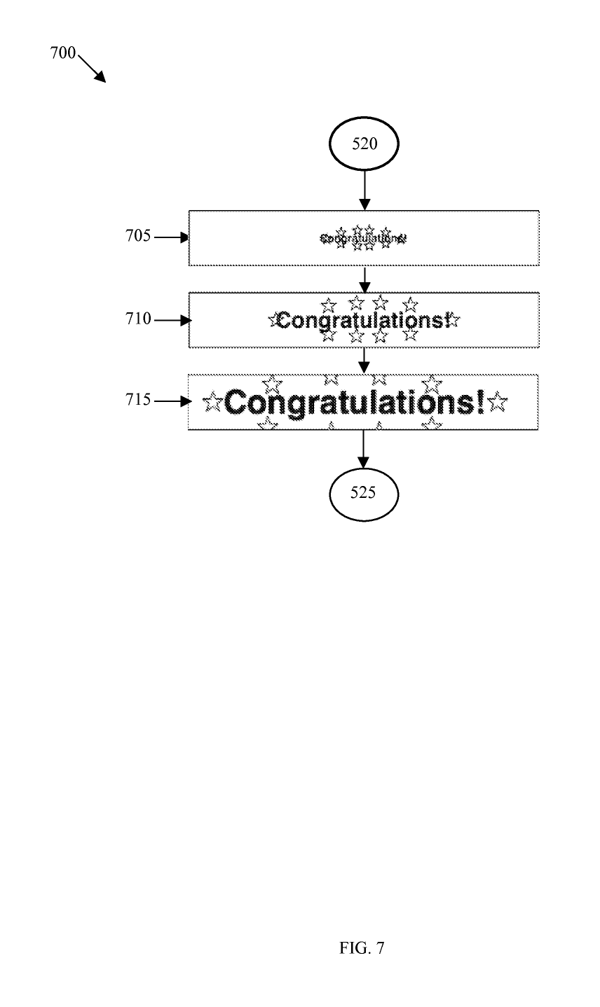

At step 525, the step comprises displaying the entire WIN banner. The WIN banner displays the image, text or an image and text as entered in steps 115 and 230. In some embodiments, the WIN may comprise the word CONGRATULATIONS! In some embodiments, the WIN may comprise multiple images in an animation image. FIG. 7 shows one example.

At step 530, the step comprises displaying a TAP TO REDEEM banner. The TAP TO REDEEM banner displays the image, text or image and text as entered in steps 120 and 245. In some embodiments, a TAP TO REDEEM banner may instead state “CONGRATULATIONS”, “CLICK HERE”, “WIN” or another message. FIG. 5 shows two examples of TAP TO REDEEM banners.

In some embodiments, the WIN banner and the TAP TO REDEEM banner may be same banner. Thus in these embodiments, steps 525 and 530 are combined as one step.

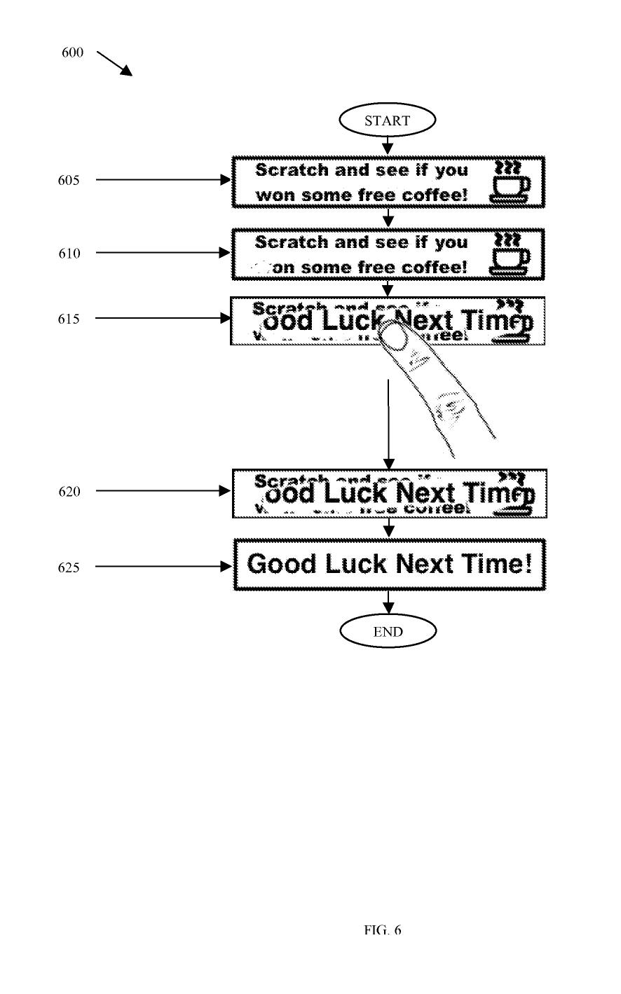

FIG. 6 shows an exemplary process displaying an interactive banner that suggests a redemption value may be obtained and displaying a LOSE banner.

At step 605, the step comprises displaying a SCRATCH banner.

At step 610, the step comprises receiving at least one screen touch signal representing at least one image location. As shown on the image at step 610, a tap (here, a rather wide one) on the screen where “won” appears caused the pixels to become transparent. The underlying banner then begins to appear.

At step 615, the step comprises receiving a plurality of screen touch signals representing contiguous image locations. As more screen touches are received, more of the underlying banner appears.

Step 620 shows step 615 without a user's finger to show the partial LOSE banner.

At step 625, the step comprises displaying the entire LOSE banner. The LOSE banner displays the image, text or an image and text as entered in steps 125 and 260. FIG. 6 shows one example of a LOSE banner. In some embodiments, the LOSE banner may state “TRY AGAIN”, “TRY AGAIN LATER”, “GOOD LUCK NEXT TIME”, “BETTER LUCK NEXT TIME”, or another message.

In most embodiments, the process then displays an ad for the advertiser, or displays another SCRATCH banner. The AD banner displays the image, text or an image and text as entered in steps 130 and 260. FIG. 1 shows one example of an AD banner.

FIG. 7 shows an exemplary animation image displaying a WIN banner with the word CONGRATULATIONS! from steps 520 and 525. The banners in FIG. 7 are merely illustrative embodiments and teachings of the present invention. All variations are within the spirit and scope of the present invention. These exemplary banners are not to be considered as limiting the present invention to only the embodiments illustrated.

At step 705, the step comprises showing the word CONGRATULATIONS! in a small font with a pattern of stars slightly above the word CONGRATULATIONS!, slightly below the word CONGRATULATIONS!, and to the left and right of the word CONGRATULATIONS!

At step 710, the step comprises showing the animation image of step 705 scaled larger than in step 705.

At step 715, the step comprises showing the animation image of step 705 scaled larger than in step 710.

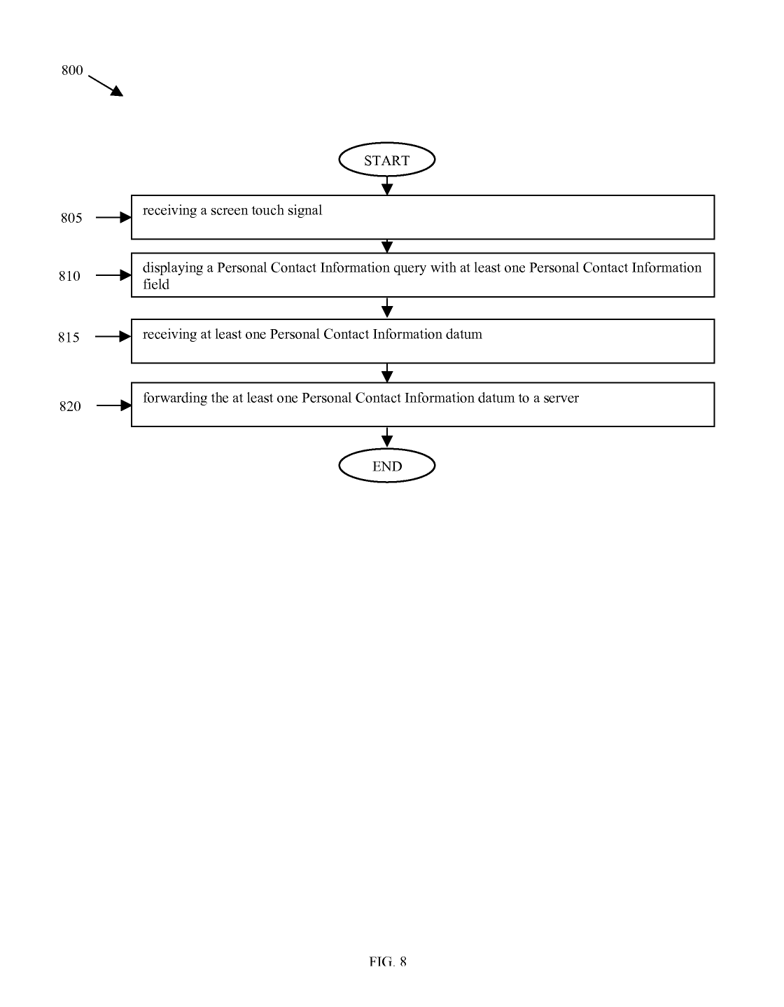

FIG. 8 shows an exemplary process for displaying an interactive screen for collecting

Personal Contact Information, and sending the Personal Contact Information to a server.

At step 805, the step comprises receiving a screen touch signal. In some embodiments, the screen touch signal may represent a single pixel. In some embodiments, the screen touch signal may represent a plurality of pixels.

At step 810, the step comprises displaying a Personal Contact Information banner with at least one Personal Contact Information field.

At step 815, the step comprises receiving at least one Personal Contact Information datum.

At step 820, the step comprises forwarding the at least one Personal Contact Information datum to a server.

These descriptions and drawings are embodiments and teachings of the present invention. All variations are within the spirit and scope of the present invention. This disclosure is not to be considered as limiting the present invention to only the embodiments illustrated.

What is claimed is:

1. A method for creating a virtual scratch banner comprising:
receiving at least one of a scratch banner text, a scratch banner image or both,
creating a scratch banner containing at least one of the scratch banner text and the scratch banner image,
receiving at least one of a win banner text, a win banner image, or both,
creating a win banner containing at least one of the win banner text and the win banner image,
receiving at least one of a Tap to Redeem banner text, a Tap to Redeem banner image, or both,
creating a Tap to Redeem banner containing at least one of the Tap to Redeem banner text and the Tap to Redeem banner image,
receiving at least one of a lose banner text, a lose banner image, or both,
creating a lose scratch banner containing at least one of the lose banner text and the lose banner image,
receiving at least one of an ad banner text, an ad banner image, or both, and
creating an ad banner containing at least one of the ad banner text and the ad banner image.

2. The method for creating a virtual scratch banner of claim 1 further comprising receiving a predetermined banner image size.

3. The method for creating a virtual scratch banner of claim 1 further comprising receiving at least one of a scratch banner image size, a win banner image size, a Tap to Redeem banner size, a lose banner size, or an ad banner image size.

4. A method for a virtual scratch banner redemption program comprising:
receiving a list of at least one prize,
receiving a list of at least one ad,
assigning at least one prize to at least one ad,
selecting one of a win or lose determination,
assigning the win or lose determination to a scratch banner,
selecting a prize, and
assigning the prize to the scratch banner.

5. A method for displaying and processing a virtual scratch banner comprising:
displaying a virtual scratch banner having a banner image size,
receiving at least one screen touch signal representing at least one image location,
pausing an ad refresh timer while receiving at least one screen touch signal representing at least one image location,
converting the at least one image location of the virtual scratch banner to transparency and showing corresponding image locations of a win banner or a lose banner at the at least one image location
receiving a plurality of screen touch signals representing contiguous image locations,
resetting the ad refresh timer to zero,
counting the plurality of screen touch signals representing contiguous image locations,
displaying a win banner or a lose banner at the contiguous image locations,
calculating a ratio of the plurality of screen touch signals representing the contiguous image locations to the banner image size,
determining whether the ratio of the plurality of screen touch signals representing contiguous image locations to a the banner image size, and
displaying a tap to redeem banner if the ratio of the plurality of screen touch signals representing contiguous image locations to a the banner image size.

6. The method for displaying and processing a virtual scratch banner of claim 5 wherein the reveal criteria is about 65 percent.

7. The method for displaying and processing a virtual scratch banner of claim 5 wherein the reveal criteria is exceeds 10 percent

8. The method for displaying and processing a virtual scratch banner of claim 5 further comprising making a win or lose determination and selecting a win banner or a lose banner based on the win or lose determination.

9. The method for displaying and processing a virtual scratch banner of claim 5 wherein the WIN banner displays “CONGRATULATIONS”.

10. The method for displaying and processing a virtual scratch banner of claim 5 wherein the WIN banner comprises multiple images in an animation image.

11. The method for displaying and processing a virtual scratch banner of claim 5 wherein the LOSE banner displays “TRY AGAIN”.

12. The method for displaying and processing a virtual scratch banner of claim 5 wherein the scratch banner image size is 320 pixels by 50 pixels.

13. The method for displaying and processing a virtual scratch banner of claim 5 wherein the scratch banner image size is 760 pixels by 100 pixels.

14. The method for displaying and processing a virtual scratch banner of claim 5 further comprising:
receiving a screen touch signal,
displaying a Personal Contact Information banner with at least one Personal Contact Information field,
receiving at least one Personal Contact Information datum, and
forwarding the at least one Personal Contact Information datum to a server.
